(19) United States
(12) Patent Application Publication
(10) Pub. No.: US 2021/0103814 A1
(43) Pub. Date: Apr. 8, 2021

(54) Information Robust Dirichlet Networks for Predictive Uncertainty Estimation

(71) Applicant: Massachusetts Institute of Technology, Cambridge, MA (US)

(72) Inventor: Theodoros Tsiligkaridis, Chestnut Hill, MA (US)

(21) Appl. No.: 17/064,046

(22) Filed: Oct. 6, 2020

Related U.S. Application Data
(60) Provisional application No. 62/911,342, filed on Oct. 6, 2019.

(51) Int. Cl. G06N 3/08; G06N 5/04

(52) U.S. Cl. CPC G06N 3/08; G06N 5/04

(57) ABSTRACT

A method for an application provides weights for a neural network configured to dynamically generate a training for the neural network to detect uncertainty with regards to data input to the neural network. A training loss is determined for the neural network to minimize an expected Lp norm of a prediction error, wherein prediction probabilities follow a Dirichlet distribution. A closed-form approximation to the training loss is derived. The neural network is trained to infer parameters of the Dirichlet distribution, wherein the neural network learns distributions over class probability vectors. The Dirichlet distribution is regularized via an information divergence. A maximum entropy penalty is applied to an adversarial example to maximize uncertainty near an edge of the Dirichlet distribution.

### CROSS-REFERENCE TO RELATED APPLICATIONS

This application claims the benefit of U.S. Provisional Patent Application Ser. No. 62/911,342, filed Oct. 6, 2019, entitled “Information Robust Dirichlet Networks for Predictive Uncertainty Estimation,” which is incorporated by reference herein in its entirety.

### GOVERNMENT LICENSE RIGHTS

This invention was made with Government support under Grant No. FA8702-15-D-0001 awarded by the U.S. Air Force. The Government, has certain rights in the invention.

### FIELD OF THE INVENTION

The present invention relates to training data for a neural network, and more particularly, is related to preprocessing data in dirichlet networks for predictive uncertainty estimation.

### BACKGROUND OF THE INVENTION

Precise estimation of uncertainty in predictions for artificial intelligence (AI) systems is an important factor in ensuring trust and safety. Conventionally trained neural networks (NN) tend to be overconfident as they do not account for uncertainty during training. For example, if a neural net is conventionally trained to expect a first type of data (such as images of a automobiles), upon receiving a second type of data. (for example, an image of an aircraft), the NN may attempt to resolve the data as an image of an automobile.

Deep learning systems have achieved state-of-the-art performance in various domains. The first successful applications of deep learning include large-scale object recognition and machine translation. While further advances have achieved strong performance and often surpass human-lever ability in computer vision, speech recognition, and medicine, bioinformatics, other aspects of deep learning are less well understood. Conventional neural networks (NNs) are overconfident in their predictions and provide inaccurate predictive uncertainty. Intepretability, robustness, and safety are becoming increasingly important as deep learning is being deployed across various industries including healthcare, autonomous driving and cybersecurity.

Uncertainty modeling in deep learning is a crucial aspect that has been the topic of various Bayesian neural network (BNN) research studies. BNNs capture parameter uncertainty of the network by learning distributions on weights and estimate a posterior predictive distribution by approximate integration over these parameters. The non-linearities embedded in deep neural networks make the weight posterior intractable and several tractable approximations have been proposed and trained using variational inference, the Laplace approximation, expectation propagation, and Hamiltonian Monte Carlo. The success of approximate BNN methods depends on how well the approximate weight distributions match their true counterparts, and their computational complexity is determined by the degree of approximation. Most BNNs take more effort to implement and are harder to train in comparison to conventional NNs. Furthermore, approximate integration over the parameter uncertainties increases the test time due to posterior sampling, and yields an approximate predictive distribution that is subject to bias, due to stochastic averaging. More recently, methods have been developed that provide good uncertainty estimates while reusing the training pipeline of existing NNs and maintaining scalability. To this end, a simple approach was proposed that combines NN ensembles with adversarial training to improve predictive uncertainty estimates in a non-Bayesian manner. It is known that deterministic NNs are brittle to adversarial attacks, and various defenses have been proposed to increase accuracy for low levels of noise.

In 2018, a study (Lee et al.) used generative adversarial networks to generate boundary samples and trained the classifier to be uncertain on those as a means to improve detection of out-of-distribution samples. While adversarial defense has been explored, there is a need in the industry for maximizing uncertainty on low-noise adversarial examples to improve predictive uncertainty estimates.

In 2019, the Dirichlet distribution was used to model distributions of class compositions and its parameters were learned by training deterministic neural networks. This approach for Bayesian classification yields closed-form predictive distributions and outperforms BNNs in uncertainty quantification for out-of-distribution and adversarial queries. However, there is a need in the industry to significantly improve out-of-distribution and adversarial queries performance.

### SUMMARY OF THE INVENTION

Embodiments of the present invention provide information robust Dirichlet networks for predictive uncertainty estimation. Briefly described, the present invention is directed to a method for an application to provide weights for a neural network configured to dynamically generate a training for the neural network to detect uncertainty with regards to data input to the neural network. A training loss is determined for the neural network to minimize at expected Lp norm of a prediction error, wherein prediction probabilities follow a Dirichlet distribution. A closed-form approximation to the training loss is derived. The neural network is trained to infer parameters of the Dirichlet distribution, wherein the neural network learns distributions over class probability vectors. The Dirichlet distribution is regularized via an information divergence. A maximum entropy penalty is applied to an adversarial example to maximize uncertainty near an edge of the Dirichlet distribution.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principles of the invention.

FIG. 1 shows plots of classification of a rotated digit 6 spanning a 180-degree rotation for standard neural network with softmax output (left) and output of the embodiments (right).

FIG. 2 is a plot of Rényi divergence illustration as αᵢ, i≠c varies for the regime {αⱼ}_{j≠c}→1 with two different values for the correct class concentration parameter α_{c}, where, u=2 and K=10.

FIG. 3 is a plot showing the distribution of entropies of predictive distributions for correct and misclassified examples across competing methods.

FIG. 4 is a plot showing empirical CDF of predictive distribution entropy on a non-MNIST dataset.

FIG. 5 includes plots showing test accuracy (left) and predictive entropy (right) for FGSM adversarial examples as a function of adversarial noise ϵ on a MNIST dataset.

FIG. 6 shows the adversarial performance of the Dirichlet-based methods (the most competitive ones) on examples generated with the projected gradient descent (PGD) method for different noise levels ϵ, i.e., x_{adv}^{t+1}= [symbol] (x_{adv}^{t}+αsgn(∇ₓ [symbol] (x_{adv}^{t},y,w))) with x_{adv}⁰=x.

FIG. 7 is a plot showing empirical CDF of predictive entropy on correct and misclassified ECG signals for various deep learning methods.

FIG. 8A is a set of plotss showing correct ECG signals from the test set; the top plots show correctly classified normal rhythms (top two) and AFib (next two) signals with low prediction entropy.

FIG. 8B shows plots of misclassified ECG signals from the test set of incorrectly classified AFib signals characterized by high prediction entropy.

FIG. 9 is a plot showing sample out-of-distribution signals for PhysioNet ECG dataset.

FIG. 10 is a plot of empirical CDF of predictive entropy and mutual information on out-of-distribution signals for various deep learning methods.

FIG. 11 is a block diagram of a first exemplary embodiment of a system implementing the present invention.

FIG. 12 is a schematic diagram illustrating an example of a system for executing functionality of the present invention.

FIG. 13 is a flowchart of an exemplary embodiment of a method for providing weights for a neural network (NN) configured to dynamically generate a training set to train the NN to detect uncertainty with regards to data input to the NN.

### DETAILED DESCRIPTION

Reference will now be made in detail to embodiments of the present invention, examples of which are illustrated in the accompanying drawings. Wherever possible, the same reference numbers are used in the drawings and the description to refer to the same or like parts.

As used within this disclosure “Lp norm” refers to function spaces defined using a natural generalization of the p-norm for finite-dimensional vector spaces. Lp spaces are sometimes called Lebesgue spaces, named after Henri Lebesgue. Lp spaces form an important class of Banach spaces in functional analysis, and of topological vector spaces. Because of their key role in the mathematical analysis of measure and probability spaces, Lebesgue spaces are used also the theoretical discussion of problems in physics, statistics, finance, engineering, and other disciplines.

As used within this disclosure “training loss” refers to a summation of the errors made for each example in training or validation sets. In the case of neural networks, the loss may typically be negative log-likelihood and residual sum of squares for classification and regression respectively.

Embodiments of the present invention are directed toward information robust Dirichlet networks that deliver more accurate predictive uncertainty than other state-of-the-art methods. The embodiments modify the output layer of neural networks and the training loss, therefore maintaining computational efficiency and ease of implementation. The embodiments include a new training loss based on minimizing the expected Lp norm of the prediction error under which the prediction probabilities follow a Dirichlet distribution. A closed-form approximation to this loss is derived, under which a deterministic neural network is trained to infer the parameters of a Dirichlet distribution, effectively teaching neural networks to learn distributions over class probability vectors. An information divergence is used to regularize the estimated Dirichlet distribution and a maximum entropy penalty on adversarial examples is used to maximize uncertainty near the edge of the data distribution. An analysis is provided that shows how properties of the new loss improve un-certainty estimation.

In contrast to Bayesian neural networks that learn approximate distributions on weights to infer prediction confidence, exemplary embodiments of the preset invention are directed to a method of training data to provide weights resulting in robust Dirichlet networks that learn the Dirichlet distribution on prediction probabilities by minimizing the expected Lp norm of the prediction error and an information divergence loss that penalizes information flow towards incorrect classes, while simultaneously maximizing differential entropy of small adversarial perturbations to provide accurate uncertainty estimates. Properties of the new cost function are derived to indicate how improved uncertainty estimation is achieved. Experiments using real datasets show that the exemplary embodiments outperform previously state-of-the-art neural networks by a large margin for estimating in-distribution and out-of-distribution uncertainty, and detecting adversarial examples.

### Overview Specific to Dirichlet Networks

In previous applications using Dirichlet networks the results were not adequate for working on real applications. This was due to the training procedure used. A comparison was made between the performance of the method of the above described embodiments and these prior works and performance was dramatically improved with the present embodiments The performance gains conic from a more complex training procedure that combines various terms, in the end providing a set of weights for the Dirichlet network that are robust to various types of information that the network is being fed, therefore “information-robust”. The weights of the Dirichlet network are denoted as w and the output of the neural network gives a positive vector α=f(x;w) that depends on the weights and the input example that the network is fed. These parameters control the shape of the Dirichlet distribution that arises when making predictions from which various types of uncertainty metrics are computed (e.g., entropy of predictive distribution, mutual information, maximum probability, etc.).

The training process and training dataset generation of the present invention are unique.

The training process of the embodiments described herein improves upon the training process of Sensoy et al. (2018) since under the embodiments the training loss function for larger p approximates the maximum-norm which minimizes the cost of the higher prediction error among classes as opposed to the mean-square error that is affected by outlier scores proposed by Sensoy et al. (2018). As a result when errors are made the uncertainty is expected to be higher as the embodiments mitigate the effect of favoring one class more than others. The training process of the embodiments further improves upon the training process of Malinin et al. (2019) which proposed minimizing the distance between the learned Dirichlet distribution and a sharp Dirichlet distribution concentrated on the correct class. The method of the embodiments does not require specifying a sharp Dirichlet distribution and instead tries to fit the best Dirichlet prior distribution to each training example, and furthermore does not rely on access to out-of-distribution data at training time to identify what is anomalous; a questionable assumption for most applications.

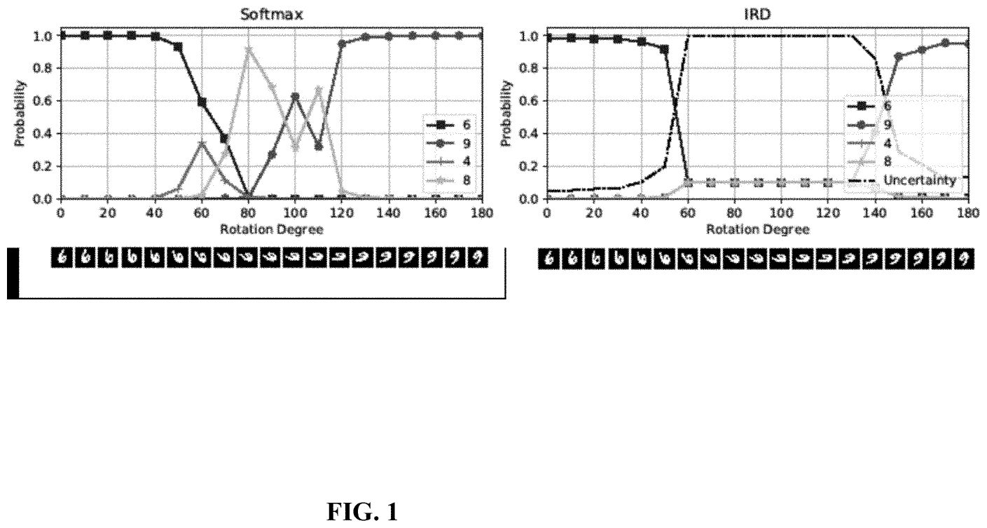

The conventional approach for the classification layer includes the softmax operator which takes continuous-valued activations of the output layer and converts them into probabilities. Typically the cross-entropy loss is used for training that provides a point estimate of the predictive class probabilities of each example and do not have a handle on the underlying uncertainty. Cross-entropy training can be probabilistically interpreted as maximum likelihood estimation, which cannot infer predictive distribution variance. As a result, this prevalent setting for training neural networks produces overconfident wrong predictions. This is illustrated in FIG. 1 in which an image of a digit 6 is correctly classified initially, but as it rotates the softmax output incorrectly classifies it with high probability as an 8. In contrast, the present embodiments yield a near-uniform distribution during the rotation stage and thus provide a reasonable uncertainty estimate using the entropy of the predictive distribution.

By proceeding in a different way from both Sensoy and Malinin, the training process of the present embodiments differs in several regards. The training process described in the embodiments directly learns the Dirichlet distribution on prediction probabilities by minimizing a training loss that combines three elements: (a) flexible calibration loss (expected Lp norm of prediction error) derived in closed-form, (b) information divergence loss (based on Renyi divergence) that penalizes information flow towards incorrect classes (in effect the learned Dirichlet distributions's spread towards incorrect classes is reduced), and (c) maximum differential entropy penalty that maximizes the distributional uncertainty on adversarial-designed data. Note that the embodiments couple this loss with the calibration loss, and adversarial examples are generated that tend to maximize the calibration loss.

The theoretical analysis provided illustrates the desirable properties of the new cost function that directly indicates how improved uncertainty estimation is achieved. Specifically, the analysis presented in Theorem 1 and 2 show that minimizing the calibration loss (a) tends to increase information flow towards correct classes and simultaneously reduce information flow towards incorrect classes which the model cannot explain. Furthermore, choosing a large p parameter in the calibration/classification loss leads to minimizing the expected worst-case prediction error, which is not considered in any of the recent prior art. This novelty, which the experiments also support, makes the training procedure learn weights in the Dirichlet network so that at the output the classifier tends to care about difficult cases, which include misclassifications or uncertain inputs, while at the same time caring about increasing the correct class likelihood. The information divergence loss (b) then tends to train the weights of the Dirichlet network so that information flow towards incorrect classes that might exhibit characteristics similar to the correct class is minimized, e.g., certain parts/features of an image are similar to those typically exhibited in an incorrect class, in effect flattening part of the Dirichlet distribution while maintaining its spread towards the correct class. Finally, maximizing the adversarial differential entropy (c) has the interesting effect of teaching the Dirichlet network (through tuning its weights) to maximize uncertainty at small adversarial perturbations near the training data manifold. These adversarial perturbations are coupled to the classification loss (a) and are designed to move data towards the direction of maximum increase of (a). This combination of (a),(b),(c) learn a robust set of weights for a Dirichlet network that is tightly fit to the training dataset, and the result of using these learned weights makes the Dirichlet network able to accurately predict uncertainty. Thus the Dirichlet neural network is very aware of the information carried in the dataset that it was trained upon. As a result, when the Dirichlet network is faced with a difficult classification query and is likely to make a mistake, or when anomalous data is presented, or when it is presented with adversarial attacks (specially designed data that are slightly different than training data that fool the network with high probability), it will tend to output a high'b, uncertain predictive distribution (parametrized by the vector α).

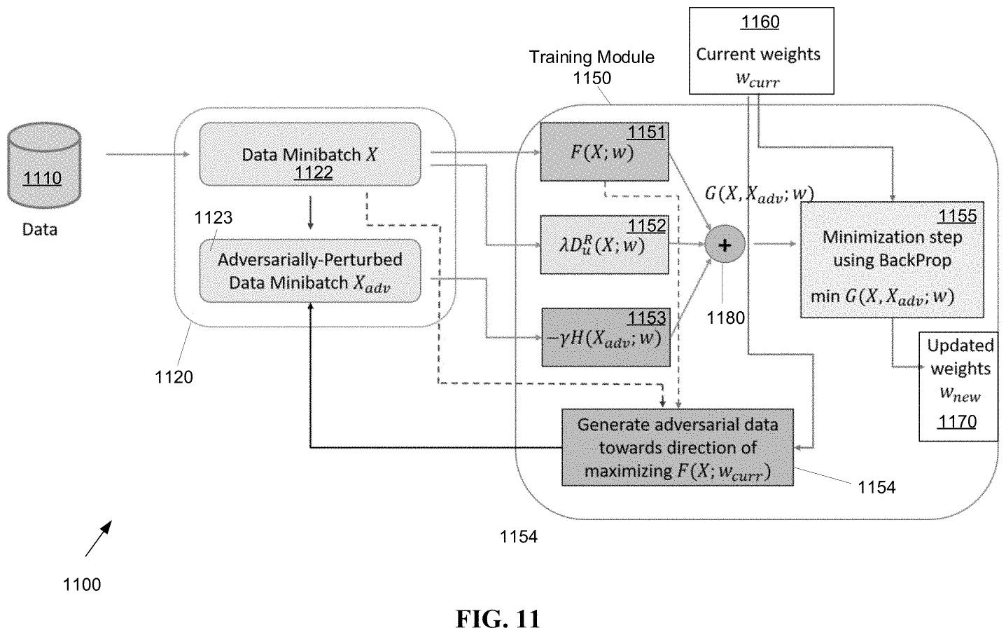

FIG. 11 is a block diagram of a system 1100 to train a Dirichlet distribution for producing weights to address uncertainty in a neural network. Typically 1,000s to 1,000,000s of data, from a data store 1110 is used to dynamically train an algorithm in a neural network.

A training data minibatch 1122 culled from the data store 1120 is provided to a training module 1150 to be used directly by two sub-modules 1151, 1152. The first sub-module 1151 receives the training minibatch 1122 as an input and determines a flexible calibration loss (expected Lp norm of prediction error) derived in closed-form. The second submodule 1152 receives the training minibatch 1122 as an input and determines an information divergence loss (based on Renyi divergence) that penalizes information flow towards incorrect classes (in effect the learned Dirichlet distributions' spread towards incorrect classes is reduced).

An adversarial data generator 1154 receives current weights 1160 produced by the submodules 1151, 1152 and the data minibatch 1122 as input and produces an adversarially-preturbed data minibatch 1123 for use by a third sub-module 1153. The third submodule 1153 receives the adversarially-preturbed data minibatch 1123 and determines a differential entropy penalty that maximizes the distributional uncertainty on adversarial-designed data. A combiner 1180, for example, a summing application, combines the outputs of the three submodules 1151, 1152, 1153 to produce a total loss to be minimized.

A minimization module 1155 receives the total loss to be minimized and the current weights and uses BackProp to produced updated weights 1170. As described further below, the updated weights are then used in the next pass of iterative weight generation. Under the first embodiment (the “total loss function”), the network is trained using the weights to recognize uncertainty. The embodiments may be used for (1) predicting errors in the NN, (2) detecting anamolous inputs to the NN, and (3) detecting adversarial attacks upon the NN. FIG. 11 shows a high level overview of the process to create training weights for the neural network. A description of the processing performed by the training module 1150 follows.

The combiner 1180 adds the three terms from the sub-modules 1151, 1152, 1153 to form the total loss to be minimized, given by

$$G ( w ) = {\sum }_{i} {G}_{i} ( w )$$

described herein. This sum is over all the training data. Training proceeds in a sequential fashion, iteratively minimizing the total loss using a process known as backpropagation or BackProp (optimization process known and used to train deep learning systems).

It should be noted there are nonnegative parameters that control the strength of the terms (b), (c) that start at zero and increase slowly during the training process to add their effect in the learned weights of the Dirichlet network. During the first few epochs (1 epoch=1 pass through training set), the network learns good weights to extract various types of features from the data at several layers of the model and combine them at the final classification softplus-based layer so that a good enough accuracy is obtained, and as the epochs increase, the effect of the information divergence term and the maximum adversarial entropy term start affecting the weight-learning process more and more. The network keeps tuning the weights and once converged, is ready for deployment and production use. For example, the network may be monitored and deemed to have converged when few or no improvements are observed.

The technical novelty lies in the training process due to the three terms it includes, but also in the training dataset generation. The adversarial entropy (c) is computed by computing the derivative of the classification loss function (a), taking its sign, and adding this scaled small perturbation to the data. So, the training dataset is dynamically changing from minibatch to minibatch (small batch of data) during the training process.

Specifically, for each minibatch of data, the network weights are updated by minimizing the total loss small patches of data examples, as well as the associated adversarially-perturbed data versions of the small batches (which are generated based on what the network has currently learned). Then for the minibatch of the next iteration, the weights are further updated by minimizing the total loss using a new set of small batch of data and adversarial perturbed data versions (generated using the updated weights) as inputs. This training process is illustrated in FIG. 11. It can be seen that the training process is coupled tightly with the training data generation.

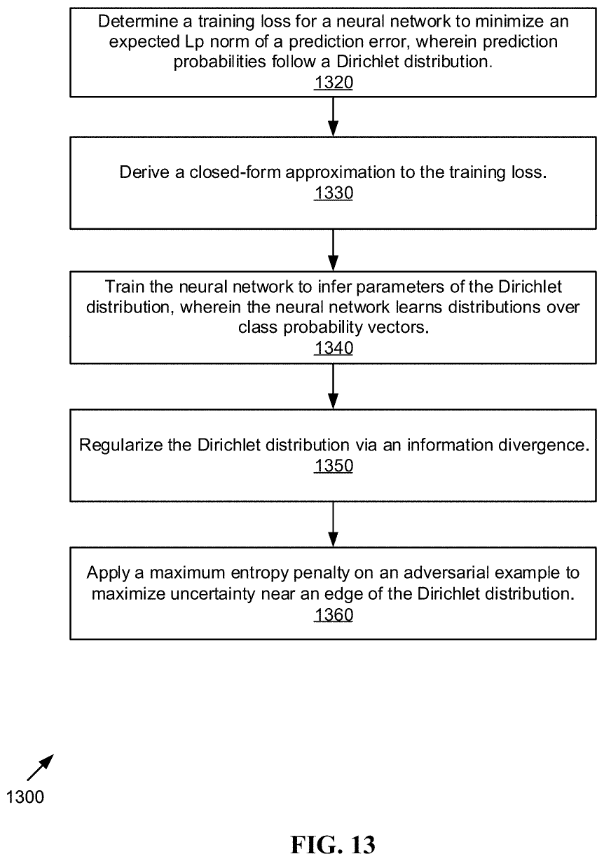

FIG. 13 is a flowchart of an exemplary embodiment of a method 1300 for an application to provide weights for a neural network configured to dynamically generate a training for the neural network to detect uncertainty with regards to data input to the neural network. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skirled in the art of the present invention.

A training loss is determined for a neural network to minimize an expected Lp norm of a prediction error, wherein prediction probabilities follow a Dirichlet distribution, as shown by block 1320. A closed-form approximation to the training loss is derived, as shown by block 1330. The neural network is trained to infer parameters of the Dirichlet distribution, wherein the neural network learns distributions over class probability vectors, as shown by block 1340. The Dirichlet distribution is regularized via an information divergence, as shown block 1350. A maximum entropy penalty is applied to an adversarial example to maximize uncertainty near an edge of the Dirichlet distribution, as shown by block 1360.

### Dirichlet Distribution

Outputs of standard neural networks for classification tasks are probability vectors over classes. The basis of our approach lies in modeling the distribution of such probability vectors for each example using the Dirichlet distribution. Given the probability simplex as [symbol] ={(p₁, . . . , p_{K}):pᵢ≥0, Σᵢ=1}, the Dirichlet distribution is a probability density function on vectors pϵ [symbol] given by

$${f}_{α} ( p ) = \frac{1}{B ( α )} {\prod }_{j = 1}^{K} {p}_{j}^{{α}_{j} - 1}$$

where B(α)=Πⱼ₌₁^{K}Γ(αⱼ)/Γ(α₀) is the multivariate Beta function. It is characterized by K parameters α=(α₁, . . . , α_{K}) here assumed to be larger than unity. The reason for this constraint is that the Dirichlet distribution becomes inverted for αⱼ<1 concentrating in the corners of the simplex and along its boundaries. In the special case of the all-ones α vector, the distribution becomes uniform over the probability simplex. The mean of the proportions is given by \hat{p}ⱼ=αⱼ/α₀. where α₀=Σⱼαⱼ is the Dirichlet strength. The Dirichlet distribution is conjugate to the multinomial distribution, with posterior parameters updated as αⱼ ⁱ=αⱼ+yⱼ for a multinomial sample y=(y₁, . . . , y_{K}). For a single sample, yⱼ=I_{{j=c}}, where c is the index of the correct class.

The marginal distributions of the Dirichlet distribution are Beta random variables, specifically, pⱼ˜Beta(αⱼ, α₀−αⱼ) with support on [0,1]. The q-th moment of the Beta distribution Beta(α′, β′) is given by

$$𝔼 [ {p}^{q} ] = {\int }_{0}^{1} {p}^{q} \frac{{{p}^{{α}^{′} - 1} ( 1 - p )}^{{β}^{′} - 1}}{{B}_{u} ( {α}^{′} , {β}^{′} )} dp = \frac{{B}_{u} ( {α}^{′} + q , {β}^{′} )}{{B}_{u} ( {α}^{′} , {β}^{′} )} \qquad ( 1 )$$

where Bᵤ(α′, β′)=Γ(α′)Γ(β′)/Γ(α′+β′) is the univariate Beta function.

### Classification Loss

Consider given data {xᵢ} and associated labels {yᵢ} drawn from a set of K classes. The class probability vectors for sample i given by pᵢ may be modeled as random vectors drawn from a Dirichlet distribution conditioned on the input xᵢ. A neural network with input xᵢ is trained to learn this Dirichlet distribution, f_{α}_{ᵢ}(pᵢ), with output αᵢ. While the layers of the Dirichlet neural network can be similar to classical NNs, the softmax classification layer is replaced by a softplus activation layer that outputs non-negative continuous values, e.g., _{α}(xᵢ;w) ϵ [symbol]
where w are the network parameters, from which produces αᵢ=g_{α}(xᵢ;w)+1.

Given one-hot encoded labels yᵢ of examples xᵢ with correct class cᵢ, the Bayes risk of the Lₚ prediction error for p≥1 is approximated using Jensen's inequality as

$$𝔼 {‖ {y}_{i} - {p}_{i} ‖}_{p} \leq {( 𝔼 [ {‖ {y}_{i} - {p}_{i} ‖}_{p}^{p} ] )}^{1 \text{/} p} = {( 𝔼 [ {( 1 - {p}_{i , {c}_{i}} )}^{p} ] + {\sum }_{j \neq {c}_{i}} 𝔼 [ {p}_{i , j}^{p} ] )}^{1 \text{/} p} \text{=:} {ℱ}_{i} ( w )$$

The max-norm can be approximated by using a large p. To calculate each term, it is noted 1−p_{i,c}_{ᵢ} has a distribution Beta(α_{i,0}−α_{i,c}_{ᵢ},α_{i,c}_{ᵢ}) due to mirror symmetry, and pᵢⱼ has distribution Beta(α_{i,j},α_{i,0}−α_{i,j}). Using the moment expression (1) for Beta random variables:

$${ℱ}_{i} ( w ) = {( \frac{{B}_{u} ( {α}_{i , 0} - {α}_{i , {c}_{i}} + p , {α}_{i , {c}_{i}} )}{{B}_{u} ( {α}_{i , 0} - {α}_{i , {c}_{i}} , {α}_{i , {c}_{i}} )} + {\sum }_{j \neq {c}_{i}} \frac{{B}_{u} ( {α}_{i , j} + p , {α}_{i , 0} - {α}_{i , j} )}{{B}_{u} ( {α}_{i , j} , {α}_{i , 0} - {α}_{i , j} )} )}^{\frac{1}{p}} = {( \frac{Γ ( {α}_{0} )}{Γ ( {α}_{0} + p )} )}^{\frac{1}{p}} {( \frac{Γ ( {\sum }_{k \neq c} {α}_{k} + p )}{γ ( {\sum }_{k \neq c} {α}_{k} )} + {\sum }_{k \neq c} \frac{Γ ( {α}_{k} + p )}{Γ ( {α}_{k} )} )}^{\frac{1}{p}}$$

The following theorem shows that the loss function [symbol] ᵢ has the correct behavior as the information flow increases towards the correct class which is consistent when an image sample of that class is observed in a Bayesian Dirichlet experiment and hyperparameters are incremented (see above regarding Dirichlet distributions).

Theorem 1. For a given sample xᵢ with correct label c, the loss function [symbol] ᵢ is strictly convex and decreasing in α_{c} increases (and increases when α_{c} decreases).

Theorem 1 shows the objective function encourages the learned distribution of probability vectors to concentrate towards the correct class. While increasing information how towards the correct class reduces the loss, it is also important for the loss to capture elements of incorrect classes. It is expected that increasing information flow towards incorrect classes increases uncertainty. The next result shows that through the loss function the model avoids assigning high concentration parameters to incorrect classes as the model cannot explain observations that are assigned incorrect outcomes.

Theorem 2. For a given sample xᵢ with correct label c, the loss function [symbol] ᵢ is increasing in αⱼ for any j≠c as αⱼ grows.

Theorem 2 implies that the loss function leads the model to push the distribution of class probability vectors away from incorrect classes.

### Information Divergence Regularization Loss

The classification lass can discover interesting patterns in the data to achieve high classification accuracy. However, the network may learn that certain patterns lead to strong information flow towards incorrect classes, e.g., circular pattern of digit 6 might, contribute to a large α associated with digit 8.

The Dirichlet distribution f_{α} may be regularized to concentrate away from incorrect classes. Given the auxiliary vector α′ᵢ=(1−yᵢ)+yᵢ\textcircled{⋅}αᵢ, the Rényi information divergence of the Dirichlet. distribution f_{α} is minimized from f_{αa′}:

$$\begin{matrix}{D}_{u}^{R} ( {f}_{α} ‖ {f}_{{α}^{′}} ) = & \frac{1}{u - 1} log {\int }_{𝒮} {{f}_{α} ( p )}^{u} {{f}_{{α}^{′}} ( p )}^{1 - u} dp \\ = & \frac{1}{u - 1} log [ \frac{B ( u α + ( 1 - u ) {α}^{′} )}{{B ( α )}^{u} {B ( {α}^{′} )}^{1 - u}} ] \\ = & log [ \frac{B ( {α}^{′} )}{B ( α )} ] + \frac{1}{u - 1} log [ \frac{B ( u α + ( 1 - u ) {α}^{′} )}{B ( α )} ]\end{matrix} \qquad ( 2 )$$

The order u>0 controls the influence of the likelihood ratio f_{α}/f_{α′} on the divergence. This divergence is minimized if and only if αᵢ=α′ᵢ, in other words when αᵢⱼ=1 for cᵢ. The extended order u=1 yields the Kullback-Leibler divergence.

Theorem 3 presents a local approximation of the divergence (2) in terms of Fisher information matrix J(α)= [symbol] [∇log f_{α}(p)∇log f_{α}(p)^{T}]=− [symbol] [∇²log f_{α}(p)].

Theorem 3. As ∥α−α′∥₂²=Σ_{j≠c}(αⱼ−1)²→0, the Rényi divergence can be locally approximated as:

$$\begin{matrix}{D}_{u}^{R} ( {f}_{α} ‖ {f}_{{α}^{′}} ) ≅ & \frac{u}{2} {( α - {α}^{′} )}^{T} J ( α ) ( α - {α}^{′} ) \\ = & \frac{u}{2} [ {\sum }_{i \neq c} {( {α}_{i} - 1 )}^{2} {ψ}^{( 1 )} ( {α}_{i} ) - {( {\sum }_{i \neq c} ( {α}_{i} - 1 ) )}^{2} {ψ}^{( 1 )} ( {α}_{0} ) ]\end{matrix}$$

where

$${ψ}^{( 1 )} ( z ) = \frac{d}{dz} ψ ( z )$$

is the polygamma function of order 1.

Theorem 3 shows that as {αⱼ}_{j≠c}→1 during the training process, the regularization term becomes proportional to the order u that controls the local curvature of the divergence function.

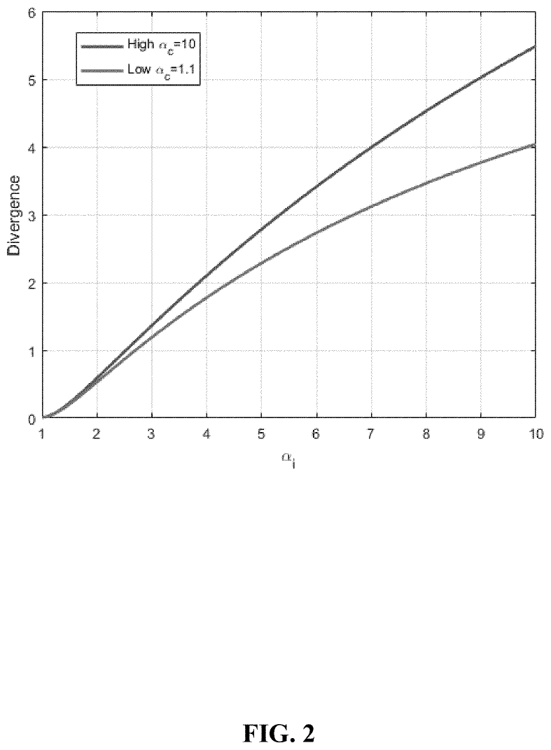

Furthermore, the asymptotic approximation. has an interesting behavior for various confidence levels α_{c}. Since the polygamma function is monotonically decreasing, it satisfies ψ⁽¹⁾(α_{c}+Σ_{i≠c}αᵢ)>ψ⁽¹⁾(α′_{c}+Σ_{i≠c}αᵢ) for α_{c}<α′_{c}. Theorem 3 implies that during training, examples that exhibit larger confidence for the correct class c have a higher Rényi divergence associated with them compared to ones with a lower confidence α_{c}. This is numerically illustrated in FIG. 2 as a function of αᵢ for some i≠c, when all concentration parameters are held fixed close to 1 and αhas a low or high value. This implies that the model tends to learn to yield sharper Dirichlet distributions when the correct class confidence is higher since the Rényi divergence is minimized by concentrating away from incorrect classes through {αⱼ}_{j≠c}→1.

Maximum Adversarial Entropy Regularization Loss

To further improve the network robustness, low-noise adversarial examples are first generated using the fast gradient sign method (FGSM),

x_{adv}=x+ϵ⋅sgn(∇ₓ [symbol] (x,y,w)).

Then the Dirichlet network generates α_{adv} that parametrize a distribution on the simplex f(p|x_{adv},w)=f_{α}_{_{adv}}(p), and the differential entropy of this Dirichlet distribution is maximized:

$$\begin{matrix}ℋ ( {f}_{{α}_{adv}} ( p ) ) = & - {\int }_{𝒮} {f}_{{α}_{adv}} ( p ) log {f}_{{α}_{adv}} ( p ) dp \\ = & log B ( {α}_{adv} ) + ( {α}_{0 , adv} - K ) ψ ( {α}_{0 , adv} ) - \\ & {\sum }_{j = 1}^{K} ( {α}_{j , adv} - 1 ) ψ ( {α}_{j , adv} )\end{matrix}$$

This differential entropy captures distributional uncertainty and is maximized when all probability vectors have the same likelihood (pushing α_{adv} towards the all-ones vector). This penalty has the effect of robustifying the predictive Dirichlet distributions inferred by the network so that small adversarial perturbations of the inputs yield high distributional uncertainty. In our experiments we find that this improves the out-of-distribution uncertainty estimation performance as well.

The total loss is [symbol] ᵢ= [symbol] ᵢ+λDᵤ^{R}(f_{α}_{ᵢ}∥f_{α′}_{ᵢ})−γ [symbol] (f_{α}_{_{i,adv}}) where λ, γ are nonnegative parameters controlling the tradeoff between minimizing the approximate Bayes risk and the information regularization penalties. The total loss is summed over a batch of training samples [symbol] (w)=Σᵢ₌₁^{N} [symbol] ᵢ(w). Training is performed using minibatches and the adversarial FGSM examples are generated for every minibatch as training progresses with λ, γ increasing using an annealing schedule, e.g., λₜ=λ(1−e^{-0.05t}), γₜ=γ min(1,t/40).

### Uncertainty Metrics

Dirichlet networks generate α=g_{α}(x*;w)+1 that correspond to a Dirichlet distribution on the simplex f(p|x*, w)=f_{α}(p). The predictive distribution is given by

$$P ( y = j \vert {x}^{*} ; w ) = {𝔼}_{{f}_{α} ( p )} [ P ( y = j \vert p ) ] = \frac{{α}_{j}}{{α}_{0}}$$

Predictive entropy measures total uncertainty and can be decomposed into knowledge uncertainty (arises due to model's difficulty in understanding inputs) and data uncertainty (arises due to class-overlap and noise). This uncertainty metric is given by:

$$H ( {𝔼}_{{f}_{α} ( p )} [ P ( y \vert p ) ] ) = - {\sum }_{j} \frac{{α}_{j}}{{α}_{0}} log \frac{{α}_{j}}{{α}_{0}}$$

The mutual information between the labels y and the class probability vector p, I(y, p|x*; w), captures knowledge uncertainty, and can be calculated by subtracting the expected data uncertainty from the total uncertainty:

$$\begin{matrix}I ( y , p \vert {x}^{*} ; w ) = H ( {𝔼}_{{f}_{α} ( p )} [ ( y \vert p ) ] ) - {𝔼}_{{f}_{α} ( p )} [ H ( P ( y \vert p ) ) ] \\ = - {\sum }_{j} \frac{{α}_{j}}{{α}_{0}} ( log \frac{{α}_{j}}{{α}_{0}} - ψ ( {α}_{j} + 1 ) + ψ ( {α}_{0} + 1 ) )\end{matrix}$$

This metric is useful when measuring uncertainty for out-of-distribution or adversarial examples, and a variation of it was used in the context of active learning.

### Practical Application Examples

The following describes results of implementations in accordance with the embodiments described herein. Two sets of functionality are exemplified/provided, a first directed to an image dataset (for handwritten digit recognition) and a second directed to an ECG signal dataset (for heart arrhythmia condition diagnosis). In the context of digital image classification (practical application 1), the training process and training dataset generation support achieving the following technical purposes:
(a) predict when AI system will likely make an error given similar digital images as those used in the training and testing set,
(b) maintain high prediction accuracy,
(c) detect anomalous digital images with high confidence unlike the ones used for training (e.g., if training to classify different types of cars, then an airplane or truck image would be considered anomalous), and
(d) detect adversarial attacks designed to fool the classifier (those are generated typically using knowledge of the network structure and classification loss) with high confidence, and are hard to detect with the human eye.

### Practical Application 1: MNIST Dataset

In the following experimental results (practical application 1), a LeNet CNN architecture with 20 and 50 filters of size 5×5 was use for the MNIST dataset with 500 hidden units at the dense layer. The training set contained 60,000 digits and the testing set contained 10,000. Comparisons are made with the following methods:
(a) L2 corresponds to deterministic neural network with softmax output and weight decay,
(b) Dropout is an uncertainty estimation method,
(c) Deep Ensemble is a non-Bayesian approach,
(d) FFG is a first BNN,
(e) FFLU is a second BNN used with an additive parameterization,
(f) MNFG is a multiplicative normalizing flow VI inference method,
(g) PN is a reverse KL divergence-based prior network method,
(h) EDL is an evidential approach, and
(i) IRD is according to the above described embodiments.

In the implementation of PN and IRD, FGSM adversarial examples were generated using ϵ=0.1 noise. Hyperparameter values u=2.0, λ=0.5, γ=0.1 were used to generate these results with p=15. Table 1 shows the test accuracy on MNIST for these methods; IRD is shown to be competitive assigning low uncertainty to correct predictions and high uncertainty to misclassifications.

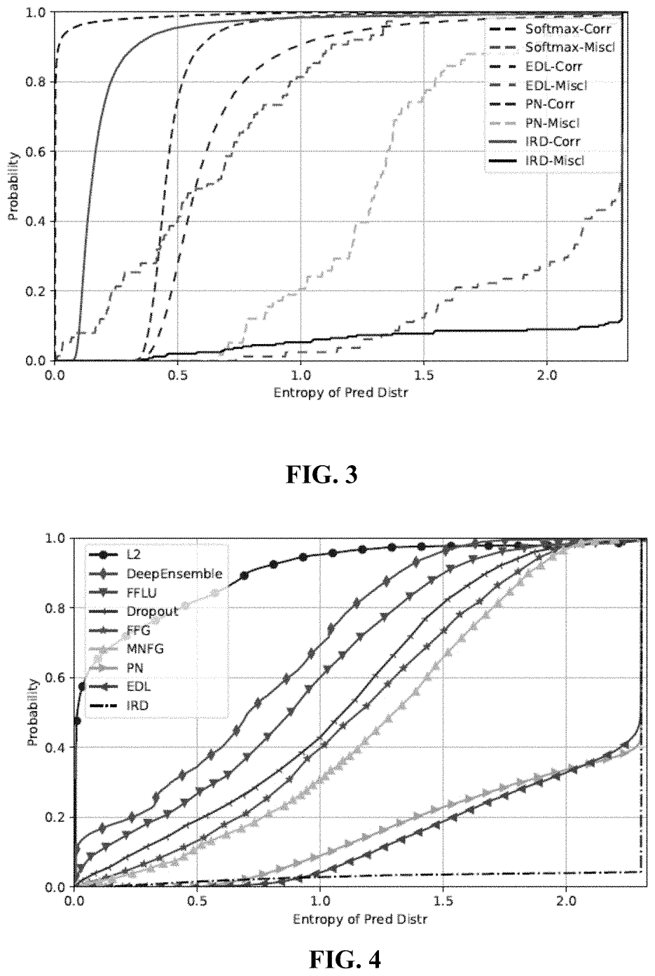

FIG. 3 shows the distribution of entropies of predictive distributions for correct and misclassified examples across competing methods. The over-confidence of softmax NNs is evident since both correct and wrong entropy

TABLE 1
Test accuracy (%) on MNIST dataset
for various deep learning methods

| | | Median | Median |
|---|---|---|---|
| | | % Max- | % Max- |
| | | Entropy- | Entropy- |
| Method | Accuracy | Correct | Misclassified |
| L2 | 99.4 | — | — |
| Dropout | 99.5 | — | — |
| Deep | 99.3 | — | — |
| Ensemble | | | |
| FTG | 99.1 | — | — |
| FFLU | 99.1 | — | — |
| MNFG | 99.3 | — | — |
| PN | 99.3 | 19.5 | 56.7 |
| EDL | 99.2 | 24.9 | 99.6 |
| IRD | 98.2 | 6.4 | 100.0 |

distributions are concentrated on lover uncertainties. The Dirichlet-based methods, EDL and PN, are better calibrated offering a good balance between correct and misclassified entropies. IRD offers a drastic improvement over all methods with 90% of the misclassified samples falling within 95% of the max-entropy (log 10≈2.3), as opposed to 58% and 5% of the misclassified samples of the PN and EDL methods respectively.

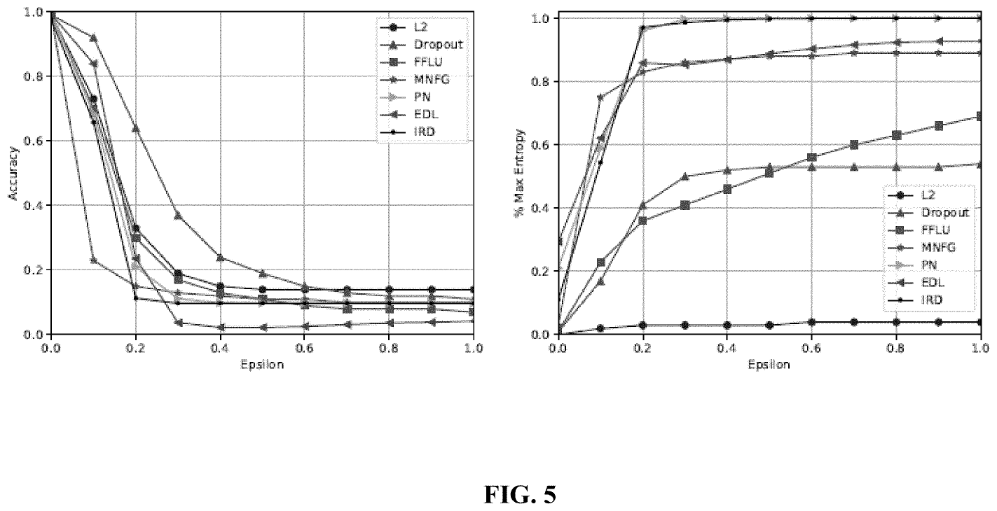

IRD was tested on notMNIST which contains only letters serving as out-of-distribution data. The uncertainty is expected to be high for all such images as letters do not fit into any digit category. FIG. 4 shows the empirical CDF of the predictive entropy for all models. CDF curves close to the bottom right are more desirable as higher entropy is desired for all predictions. IRD is much more tightly concentrated towards higher entropy values with an impressive 96% of letter images having entropy larger than 95% of the max-entropy, while EDL and PN have 61% and 63% approximately.

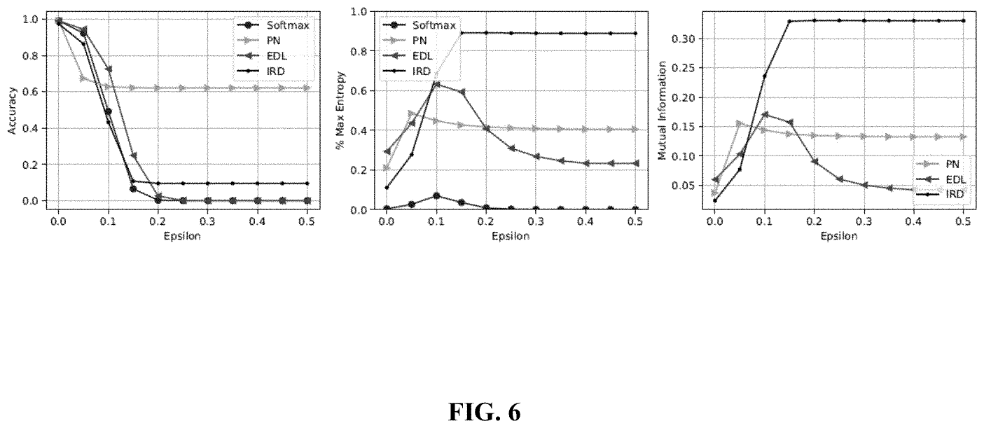

FIG. 5 shows the adversarial performance when each model is evaluated using adversarial examples generated with the Fast Gradient Sign method (FGSM) for different noise values ϵ, i.e., x_{adv}=x+ϵsgn(∇ₓ [symbol] (x,y,w)). We observe that IRD achieves higher entropy on adversarial examples as ϵ increases. Dropout outperforms other BNN methods at the expense of overconfident predictions. While PN asymptotically achieves very high uncertainty as well to the same level as IRD, we remark that IRD achieves a lower average predictive entropy for ϵ=0 due to the higher confidence of correct predictions and assigns a large entropy to misclassified samples as FIG. 3 also supports.

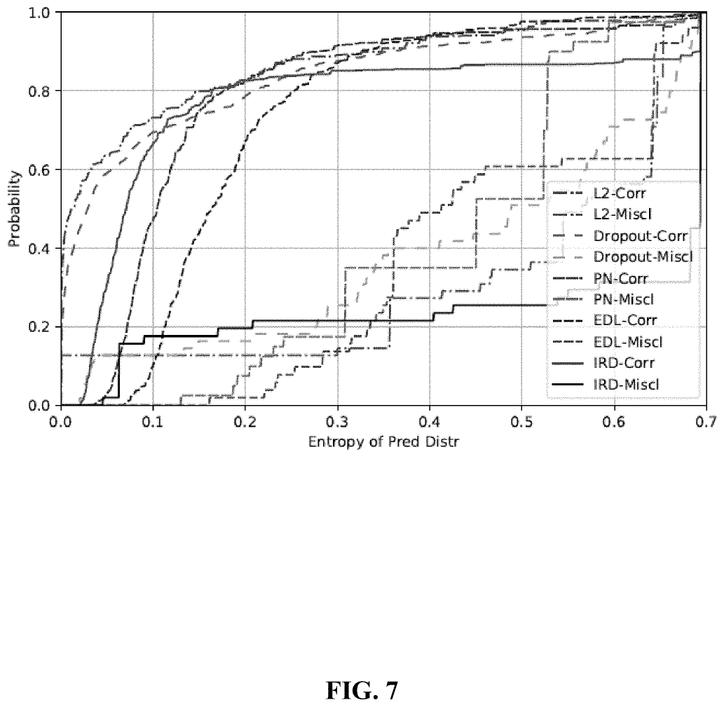

FIG. 6 shows the adversarial performance of the Dirichlet-based methods (the most competitive ones) on examples generated with the projected gradient descent (PGD) method (Kurakin et al. (2017)) for different noise levels ϵ, i.e., x_{adv}^{t+1}=II_{x+ϵl}_{_{∞}}(x_{adv}^{t}+αsgn(∇ₓ [symbol] (x_{adv}^{t}, y,w))) with x_{adv}⁰=x. Here, II_{x+ϵl}_{_{∞}}(⋅) is the projection onto the l_{∞}ball of size ϵ centered at x. This multi-step variant of FGSM uses a small step size α=0.01 over T=40 steps. We observe that IRD achieves the highest uncertainty on PGD adversarial examples as the noise level increases while PN asymptotically achieves a mid-range uncertainty, EDL is inconsistent and Softmax NNs cannot reliably detect these stronger attacks. We further remark that IRD has lower predictive entropy for ϵ=0 due to the higher confidence of correct predictions as FIG. 3 also shows.

Practical. Application 2: PhysioNet ECG Dataset
In the ECG-based heart arrhythmia diagnosis practical application 2), the training process and training dataset generation support achieving the following technical purposes: (a) predicting when AI system will likely mistake as normal rhythm for atrial fibrillation and vice-versa; this typically occurs if there is electrode contact noise, motion artifacts, muscle contractions, etc., (b) maintaining high prediction accuracy, and (c) detecting anomalous ECG signals (e.g. too noisy or not indicative of either type of normal or atrial fibrillation rhythm).

In this application, a PhysioNet17 challenge dataset contains 5, 707 electrocardiogram (ECG) signals of length 9,000 sampled at 300 samples/sec. The task is to classify a single short ECG lead recording into a normal sinus rhythm or atrial fibrillation (Afib). Atrial fibrillation is the most common sustained cardiac arrhythmia occurring when the heart's upper chambers beats out of synchronization with the lower chambers, and is hard to detect due to its episodic presence. The raw ECG signals were bandpass filtered for baseline wander removal, and then normalized to zero mean and unit variance over the 30s duration.

The CNN architecture consists of six 1D Conv layers with stride-2 max-pooling, with 8, 16, 32, 64, 128, 128 filters of sizes 9, 9, 7, 7, 5, 5 respectively, followed by a filter-vise sum-pooling layer, 100 hidden units with dropout and a binary classification layer. About 13% of the recordings correspond to Afib, and oversampling was used to account for class imbalance. A train/test split of 90%/10% was used. As EDL and PN were shown to be most competitive with our method based on the benchmark image dataset shown above, we compare IRD with the L2, Dropout, PN and EDL methods. The hyperparameters used were u=0.95, λ=2.3, γ=0.07, ϵ=0.02 with p=15.

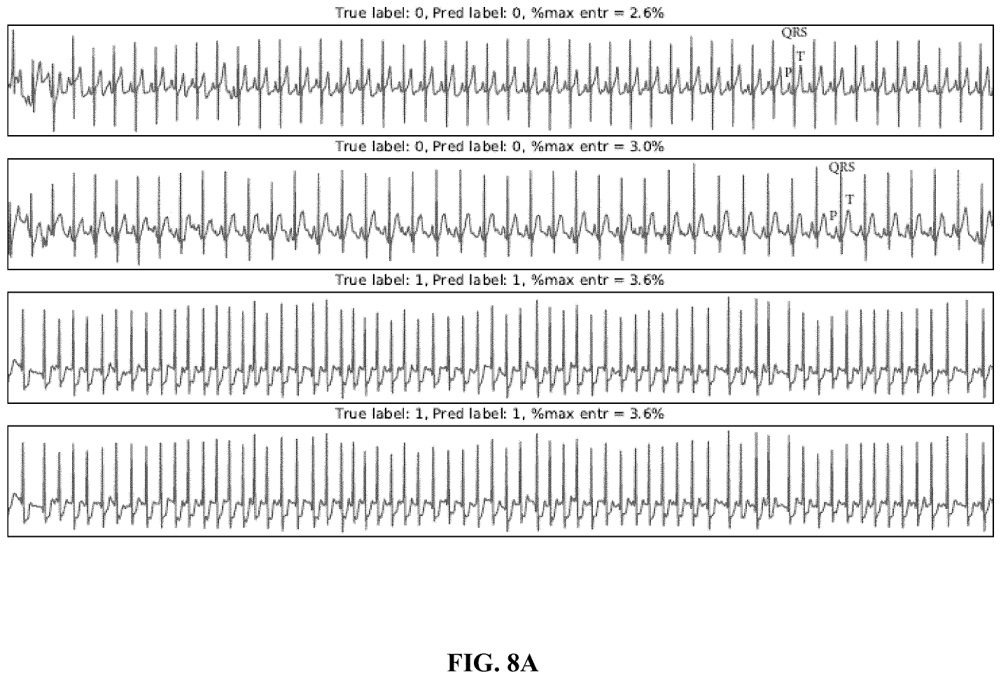

The accuracies of all methods are shown in Table 2 and IRD achieves a high prediction accuracy on par with other methods. FIG. 7 shows the cumulative density function of the predictive entropy for correct and misclassified examples. The median entropy normalized by the maximum entropy is shown in the last two columns of Table 2, which reflects that IRD assigns very low uncertainty for correct classifications and large uncertainty to misclassifications. The tail of the entropy distribution of misclassified samples shows that IRD assigns entropy values larger than 90% of the max-entropy to 69% of the misclassified samples while L2, Dropout, PN and EDL methods assign that to only 44%, 27%, 3% and 37% of their misclassified examples respectively.

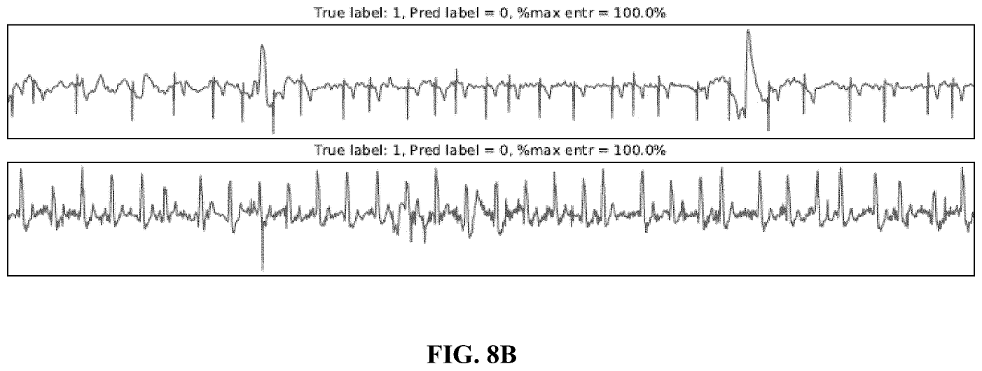

FIGS. 8A-8B respectively show correct and misclassified ECG signals

TABLE 2
Test accuracy (%) on PhysioNet ECG
dataset for various deep learning methods

| | | Median | Median |
|---|---|---|---|
| | | % Max- | % Max- |
| | | Entropy- | Entropy- |
| Method | Accuracy | Correct | Misclassified |
| L2 | 94 | 1.7 | 81.4 |
| Dropout | 94 | 4.2 | 70.4 |
| PN | 96 | 15.1 | 65.0 |
| EDL | 95 | 23.4 | 59.5 |
| IRD | 95 | 10.2 | 100.0 |

from the test set; the plots of FIG. 8A show correctly classified normal rhythms (top two) and AFib (next two) signals with low prediction entropy, and in FIG. 8B the two plots show incorrectly classified AFib signals characterized by high prediction entropy. It is evident that the method correctly forms high-confidence opinions about signals that exhibit strong characteristics of normal heartbeat (e.g., regular occurrence with identifiable P wave, QRS complex and T wave) and AFib (e.g., irregular spacing of pulses with often a lack of a P wave). Visual inspection of the high-entropy misclassified signals show that although local peaks tend to be irregular hinting at AFib, but there is too much noise in the intermediate waves and transient irregularity to reliably classify them.

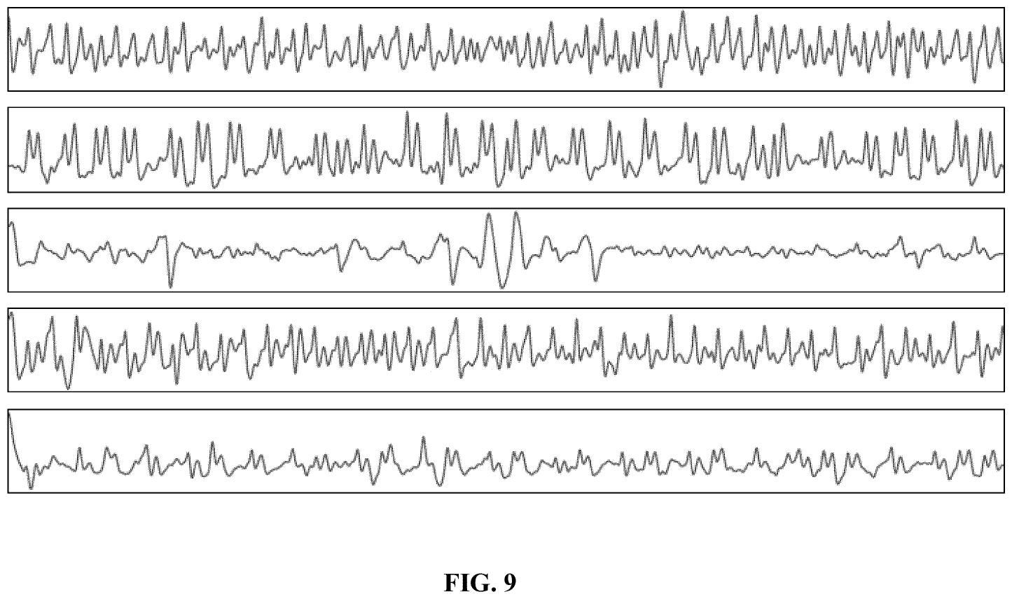

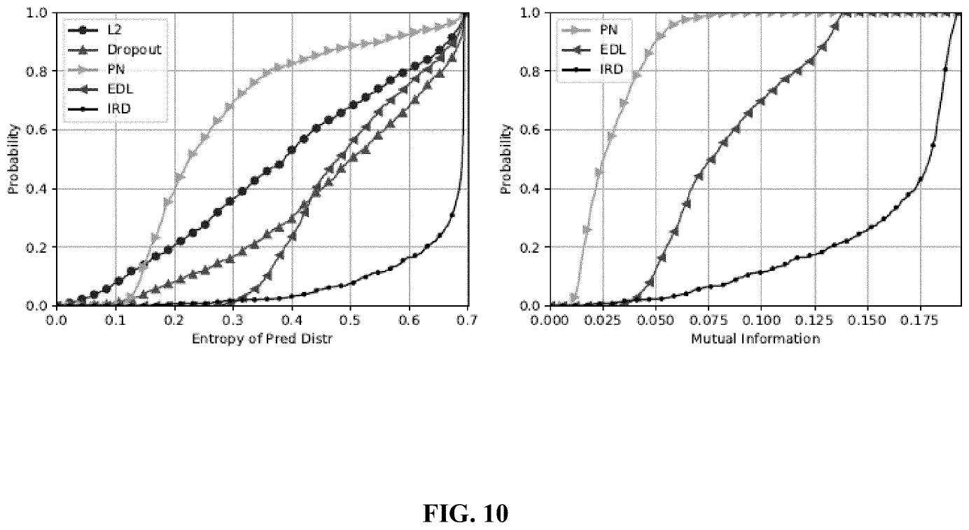

To test detection of out-of-distribution signals, eye constructed a modified dataset from the test set by adding sparse random noise (zero-mean Gaussian with σ=5 at 5% of total time locations uniformly at random) followed by temporally smoothing the whole waveform with a 1D Gaussian filter σ=15. FIG. 9 contains several anomalous generated waveforms. Empirical CDFs of predictive entropy and mutual information are shown in FIG. 10, in which IRD outperforms other methods by a large margin. Specifically, IRD assigns a predictive entropy of 90% max-entropy or higher to 81% of the anomalous signals as opposed to 17%, 27%, 6%, 20% for L2, Dropout, PN and EDL methods respectively.

As shown herein, the embodiments obtain significant improvements in uncertainty estimation in comparison to state-of-the-art neural networks. Three technical purposes are addressed by the embodiments: (a) assigning higher uncertainty to misclassifications and lower uncertainty to correctly classified examples in comparison to state-of-the-art; thus the AI may predict errors with confidence, (b) achieving significantly higher uncertainties for samples not seen in the training and test distribution of examples (and can therefore reliably detect anomalous examples) in comparison to state-of-the-art; anomaly detection with high confidence, and (c) detecting adversarial attacks (so that the trained neural network architecture is fooled the most) with higher reliability in comparison to state-of-the-art; adversarial attack detection.

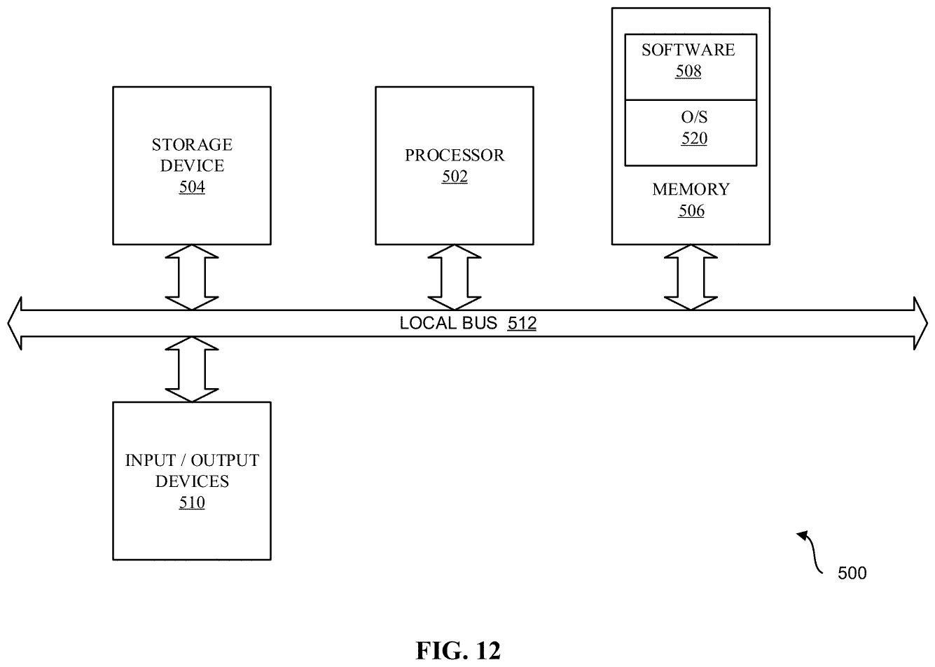

A system used to execute the functionality described in detail above may be a computer, an example of which is shown in the schematic diagram of FIG. 12. The system 500 contains a processor 502, a storage device 504, a memory 506 having software 508 stored. therein that defines the abovementioned functionality, input and output (I/O) devices 510 (or peripherals), a local bus, or local interface 512 allowing for communication within the system 500. The local interface 512 can be, for example but not limited to, one or more buses or other wired or wireless connections, as is known in the art. The local interface 512 may have additional elements, which are omitted for simplicity, such as controllers, buffers (caches), drivers, repeaters, and receivers, to enable communications, Further, the local interface 512 may include address, control, and/or data, connections to enable appropriate communications among the aforementioned components.

The processor 502 is a hardware device for executing software, particularly that stored in the memory 506. The processor 502 can be any custom made or commercially available single core or multi-core processor, a central processing unit (CPU), an auxiliary processor among several processors associated with the present system 500, a semiconductor based microprocessor (in the form of a microchip or chip set), a macroprocessor, or generally any device for executing software instructions.

The memory 506 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 506 may incorporate electronic, magnetic, optical, and/or other types of storage media. Note that the memory 506 can have a distributed architecture, where various components are situated remotely from one another, but can be accessed by the processor 502.

The software 508 defines functionality performed by the system 500, in accordance with the present invention. The software 508 in the memory 506 may include one or more separate programs, each of which contains an ordered listing of executable instructions for implementing logical functions of the system 500, as described below. The memory 506 may contain an operating system (O/S) 520. The operating system essentially controls the execution of programs within the system 500 and provides scheduling, input-output control, file and data management, memory management, and communication control and related services.

The I/O devices 510 may include input devices, for example but not limited to, a keyboard, mouse, scanner, microphone, etc. Furthermore, the I/O devices 510 may also include output devices, for example but not limited to, a printer, display, etc. Finally, the 110 devices 510 may further include devices that communicate via both inputs and outputs, for instance but not tea, a modulator/demodulator (modem; for accessing another device, system, or network), a radio frequency (RF) or other transceiver, a telephonic interface, a bridge, a router, or other device.

When the system 500 is in operation, the processor 502 is configured to execute the software 508 stored within the memory 506, to communicate data to and from the memory 506, and to generally control operations of the system 500 pursuant to the software 508, as explained above.

When the functionality of the system 500 is in operation, the processor 502 is configured to execute the software 508 stored within the memory 506, to communicate data to and from the memory 506, and to generally control operations of the system 500 pursuant to the software 508. The operating system 520 is read by the processor 502, perhaps buffered within the processor 502, and then executed.

When the system 500 is implemented in software 508, it should be noted that instructions for implementing the system 500 can be stored on any computer-readable medium for use by or in connection with any computer- related device, system, or method. Such a computer-readable medium may, in some embodiments, correspond to either or both the memory 506 or the storage device 504. In the context of this document, a computer-readable medium is an electronic, magnetic, optical, or other physical device or means that can contain or store a computer program for use by or in connection with a computer-related device, system, or method. Instructions for implementing the system can be embodied in any computer-readable medium for use by or in connection with the processor or other such instruction execution system, apparatus, or device. Although the processor 502 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the system 500 is implemented in hardware, the system 500 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The above described embodiments are directed to a new method for training Dirichlet neural networks that are aware of the uncertainty associated with predictions. The training objective that fits predictive distributions to data consisted of three elements; a calibration loss that minimizes the expected Lₚ norm of the prediction error, an information divergence loss that penalizes information flow towards incorrect classes, and a maximum entropy loss that maximizes uncertainty small adversarial perturbations. We derived closed-form expressions for our training loss and desirable properties on how improved uncertainty estimation is achieved. Experimental results were shown on an image classification task and a ECG-based heart condition diagnosis task, highlighting the unmatched improvements in predictive uncertainty estimation made by our method over conventional softmax neural networks, Bayesian neural networks, and other recent Dirichlet networks trained with different criteria. Furthermore, due to the explicit modeling of the categorical distributions over classes, the embodiments do not require ensembling multiple predictions or performing multiple evaluations of the network at inference time (e.g., as BNNs do approximate integration over the parameter uncertainties to obtain approximate predictive distributions) to arrive at predictive distributions and compute uncertainty metrics.

It will be apparent to those skilled in the art that various modifications and variations can be made to the structure of the present invention without departing from the scope or spirit of the invention. In view of the foregoing, it is intended that the present invention cover modifications and variations of this invention.

What is claimed is:

1. A computer based method for an application to provide weights for a neural network configured to dynamically generate a training for the neural network to detect uncertainty data input to the neural network, comprising the steps of:
receiving a first training minibatch of data;
providing a training loss configured to minimize an expected I_{T} norm of a prediction error, wherein prediction probabilities follow a Dirichlet distribution;
deriving a closed-form approximation to the training loss;
training; the neural network to infer parameters of the Dirichlet distribution, wherein the neural network learns distributions over class probability vectors; and
regularizing the Dirichlet distribution via an information divergence.

2. The method of claim 1, further comprising the step of applying a maximum entropy penalty on an adversarial example to maximize uncertainty near an edge of the Dirichlet distribution.

3. The method of claim 1, further comprising the step of generating an adversarial minibatch of data from the first minibatch of data.

4. The method of claim 3, wherein generating the adversarial minibatch of data further comprises computing an adversarial entropy using a derivative of a classification loss function providing the training loss, and adding a sign of the adversarial entropy to the adversarial minibatch of data.

5. The method of claim 1, wherein providing the training loss further comprises the step of determining a flexible calibration loss from the first minibatch, wherein the flexible calibration loss comprises the expected Lp norm of the prediction error.

6. The method of claim 1, further comprising the step of determining an information divergence loss configured to penalize an information flow towards an incorrect class.

7. The method of claim 6 wherein the information divergence loss is based on a Renyi divergence.

8. A training system for providing weights for a neural network configured to dynamically generate a training for the neural network to detect uncertainty with regards to data input to the neural network, comprising:
a first module configured to receive a first minibatch of data, and produce a flexible calibration loss;
a second module configured to receive the first minibatch and produce an information divergence loss;
a third module configured to receive an adversarial minibatch of data and produce a differential entropy penalty;
a combiner configured to receive the flexible calibration loss, the information divergence loss, and the differential entropy penalty and determine a total loss to be minimized; and
a backpropagation module configured to receive the total loss and produce updated weights.

9. The training system of claim 8, wherein the flexible calibration loss is configured to minimize an expected Lp norm of a prediction error.

10. The training system of claim 9, wherein the prediction error follows a Dirichlet distribution.

11. The training system of claim 8, wherein the information divergence loss is configured to train the weights of a Dirichlet neural network so to minimized an information flow towards an incorrect class.

12. The training system of claim 8, wherein the differential entropy penalty is configured to produce weights to teach a Dirichlet neural network to maximize uncertainty at small adversarial perturbations near a training data manifold.

13. The system of claim 8, wherein the adversarial minibatch is generated from the first minibatch of data.
